(19) United States
(12) Patent Application Publication
(10) Pub. No.: US 2014/0341683 A1
(43) Pub. Date: Nov. 20, 2014

(54) REMOTE STORAGE SYSTEM

(71) Applicant: Adrian Min Yan LEE, BOORAGOON (AU)

(72) Inventor: Adrian Min Yan LEE, BOORAGOON (AU)

(21) Appl. No.: 14/341,161

(22) Filed: Jul. 25, 2014

Related U.S. Application Data
(63) Continuation of application No. PCT/AU2013/000134, filed on Feb. 15, 2013.

(30) Foreign Application Priority Data
Feb. 17, 2012 (AU) 2012900598

(51) Int. Cl. B62H 3/00; G06Q 30/06; G06Q 10/08

(52) U.S. Cl. CPC B62H 3/00; G06Q 10/087; G06Q 30/0645
USPC 414/227; 414/800

(57) ABSTRACT

A remote storage system for items includes contact areas at different locations for the collection of the items individually, a storage area for secure storage of the items received from the contact areas, and transportation vehicles for receiving and offloading the items at the contact areas and one or more conveying vehicles for transporting the items to and from the storage area, wherein the transportation vehicles circulate between the contact areas so that each of the contact areas exists for a discrete time period dependent on the arrival of a transportation vehicle.

### CROSS-REFERENCE TO RELATED APPLICATION

The present application is a continuation of and claims priority of PCT Application No. PCT/AU2013/000134 filed Feb. 15, 2013, which claims priority to Australian Patent Application No. 2012900598, filed Feb. 17, 2012 both of which are hereby incorporated by reference in their entireties.

### TECHNICAL FIELD

The present invention relates to a remote storage system for items, a method of implementing remote storage of items, and apparatus used in the remote storage system of items.

The invention is particularly applicable to the remote storage of items on a temporary basis.

The invention has been devised particularly, although not necessarily solely, in relation to remote storage of two-wheeled vehicles, including bicycles, motorcycles and motor scooters, on a temporary basis on behalf of users of such items.

### BACKGROUND ART

The following discussion of the background art is intended to facilitate an understanding of the present invention only. The discussion is not an acknowledgement or admission that any of the material referred to is or was part of the common general knowledge as at the priority date of the application.

Recent global trends have seen the resurgence of bicycles as a cost-effective mode of commuting. Additionally, there is a recognition that the benefits of increased bicycle commuting include a reduction of traffic congestion in urban environments, reduction in pollution and an improvement of population health. With the increasing use of bicycles for urban commuting, there is a need to provide storage facilities at which cyclists can temporarily store their bicycles.

Currently there is a wide range of static bicycle storage systems, such as lockers racks and stands, for installation at venues such as civic centres, office buildings and government buildings. Unfortunately, static bicycle storage systems have a number of disadvantages which include a reduction in available land volume, initial expense required for the installation of the storage systems, ongoing expenses required for the maintenance of the storage systems and the repair cost of damaged storage systems caused by the theft of stored bicycles. These disadvantages typically deter mass installation of static bicycle storage systems at locations. Additionally, some properties cannot be retrofitted for static bicycle storage systems due to a lack of available space.

It would be advantageous for there to be an arrangement in which a bicycle could be ridden to a location convenient for the rider, left at that location while the rider attends to other matters, and later collected by the rider from the same or another convenient location for use again.

It is against this background that the present invention has been developed.

### SUMMARY OF INVENTION

According to a first aspect of the invention, there is provided a remote storage system for items, comprising of a plurality of contact areas at different locations for the collection of the items individually, a storage area for secure storage of the items received from the plurality of contact areas, and one or more transportation vehicles for receiving and offloading the items at the plurality of contact areas and one or more conveying vehicles for transporting the items to and from the storage area, wherein the one or more transportation vehicles circulate between the plurality of contact areas so that each of the plurality of contact areas exists for a discrete time period dependent on the arrival of a transportation vehicle.

Preferably the one or more conveying vehicles are the one or more transportation vehicles

Preferably, the system comprises a transitionary staging area for the collection of items in larger quantities from the contact area.

Preferably, the contact area comprises an area to which a vehicle can be deployed for collection and return of items.

In one arrangement, the plurality of contact areas may comprise a permanent location.

In another arrangement, the plurality of contact areas may comprise a transitory location.

One form of the plurality of contact areas may comprise a designated venue, such as area outside an office building, a large area of available land such as a car park, or a location nearby a mountain bike trail. Such designated venues represent permanent locations at which contact area are established.

Another form of contact area may comprise a location which is temporarily available for use. Such a location may provide an area at which a vehicle can park on a temporary basis but nevertheless for sufficient time to allow for collection of items over a limited duration. Such a location represents a transitory location at which a contact area is established by virtue of the presence of the vehicle at that location.

Preferably, the remote storage system comprises a plurality of contact areas to provide a series of locations to which users can deliver items for temporary storage.

Preferably, the staging area comprises a designated area for the collection of items in larger quantities from the plurality of contact areas and holding the collection of items on a temporary basis prior to dispatch in bulk qualities to the storage area.

Preferably, the one or more transportation vehicles moves items between the plurality of contact areas and the staging area.

Preferably, the one or more conveying vehicles moves items between the staging area and the storage area.

There may be one or more staging areas according to the storage demands on the system.

The staging area may be a designated venue at which a relatively large land area is available for deployment.

Preferably, the storage area comprises a static location configured as a large storage area.

There may be one or more storage areas according to the storage demands on the system.

With this arrangement, the items can be delivered by users to the contact area at which they are collected and transported to the storage area at which they are held until being returned to the users. Typically, the items are returned to the intended contact area at which the items are returned to the users.

Preferably, the system comprises the staging area at which the items collected at the contact area are accommodated temporarily for subsequent transportation to the storage area. With the inclusion of the staging area, items are returned in a two-stage process, involving initial delivery to the staging area and then delivery to the intended contact area.

Preferably, the system further comprises apparatus to receive the items for transportation and storage. The apparatus may be configured as a storage module.

In a further embodiment the present invention provides a remote storage system for items, comprising of a temporary contact area for the collection of the items individually, a storage area for secure storage of the items received from the contact area and one or more transportation vehicles for receiving and offloading the items at the temporary contact area and transporting them to and from the storage area, wherein the temporary nature of the contact area is defined by the movements of the transportation vehicles.

Preferably the remote storage system comprises a plurality of temporary contact areas for the collection of the items individually, a storage area for secure storage of the items received from the plurality of contact areas and one or more transportation vehicles for receiving and offloading the items at the plurality temporary contact areas and transporting them to and from the storage area, wherein the temporary nature of the plurality of contact areas is defined by the movements of the transportation vehicles.

More particularly, the system comprises a plurality of storage modules to receive the items for transportation and storage. Typically, one or more storage modules are delivered to each of the plurality of contact areas and the items delivered to the plurality of contact areas for storage are loaded onto the modules for transportation to the staging area. The modules, together with the items loaded thereon, are retained temporarily at the staging area and thereafter transported to the storage area for storage for the intended duration.

Typically, each storage module is transported either individually or along with several other storage modules between the plurality of contact areas and the staging area. In this way, a relatively small transport vehicle (such as small truck or a trailer behind a towing vehicle) can be used to convey storage modules between the contact and staging areas. This is advantageous in inner city environments which may not conducive to larger transport vehicles.

The storage modules may be configured as pallets on which items can be accommodated and which are configured to be lifted and transported using a forklift or a pallet trolley.

The staging and storage areas can, however, be positioned at locations between which larger transport vehicles can be used to transport a larger number of storage modules.

Preferably, the items comprise two-wheeled vehicles. The remote storage system is particularly applicable to the storage of bicycles.

Preferably, the storage module comprising a base portion and an upstanding portion. With this arrangement, the base portion may be adapted to receive and support a first wheel of the vehicle and the upstanding portion may be adapted to receive and support a second wheel of the vehicle.

Preferably, the upstanding portion comprises a wall upstanding from the base portion.

Preferably, the first wheel comprises a rear wheel of a two-wheeled vehicle and the second wheel comprises the front wheel of the vehicle.

Preferably, the storage module has provision for releasably securing a plurality of two-wheeled vehicles in position on the module. This may be accomplished by releasably retaining the wheels of each vehicle.

The base portion of the storage module may comprises a first engaging means for receiving and releasably retaining one wheel of each vehicle, typically the rear wheel.

The upstanding portion may comprises second engaging means for receiving and releasably retaining the retaining the other wheel of each vehicle, typically the rear wheel.

Preferably, the first and second engaging means are so positioned relative to each other that said other wheel (typically the front wheel) is supported in an elevated condition above the base portion. More particularly, the two-wheeled vehicle is so supported that the majority, if not substantially all, of its weight is supported onto base portion through the lower wheel. In this way, the two-wheeled vehicle is suspended in a somewhat upright condition with one wheel uppermost and the other wheel lowermost.

The first engaging means may be configured as a channel associated with the base portion. The channel may be associated with the base portion in any appropriate way, such as by being mounted on the upper surface of the base accommodated within the confines of the base so as to not extend upwardly beyond the upper surface.

The two-wheeled vehicle is secured to the module by securing one to the upstanding portion via the second engaging means, and placement of the other wheel in the channel. This arrangement orientates the two-wheeled vehicle in a generally vertical position, with the upper wheel being secured to the upstanding portion and immobilised to inhibit movement of that wheel in any direction. The two-wheeled vehicle then hangs down from the upper wheel, allowing for the lower wheel to be engaged in the channel. The lower wheel is snugly engaged by the channel and typically also abutts against the upstanding wall portion. This position allows for the two-wheeled vehicle to be secured in the module in a manner whereby external forces of reasonable magnitude would not cause the lower wheel to slip within the channel. The vertical position of the two-wheeled vehicle inhibits torsion forces to impart stress and strain upon the vehicle frame, instead the torsion forces are directed to the vehicle steerer pole is designed to manage torsion forces when a rider is steering the two-wheeled vehicle.

The channel may comprise a tapered channel comprising of a base portion and a pair of wall portions. The wall portions may define a plurality of sections adapted to accommodate various sizes of wheels. In one embodiment there are three sections, being a lower section, a middle section and an upper section. The lower section comprises outwardly tapered walls of a small angle. The middle section comprises outwardly tapered walls of a larger angle. The upper section comprises straight walls perpendicular to the base which is flat. With this arrangement, the channel can accommodate the lower wheel when of various sizes and various levels of gas inflation. The configuration of the channel facilitates frictional engagement of the lower wheel in the channel, inhibiting slippage of the lower wheel during transport of the loaded module. Additionally, a securing means such as a stopper, can be located in the channel to arrest movement of the lower wheel and thereby prevent it from disengaging from the channel.

In one arrangement, the storage module may comprise two storage zones on opposed sides of a wall which defines the upstanding portion, with each storage zone being adapted to receive a plurality of two-wheeled vehicles. This arrangement is advantageous as two-wheeled vehicles stowed in the two storages zones will experience different forces during acceleration and braking of the vehicle. In particular, stowed vehicles in one zone would experience a “pull” force and stowed vehicles on the other storage zone would experience a “push” force during acceleration and braking. This ensures that different forces will act upon the steerer poles of the respective two-wheeled vehicle, so repeated wear will not incur.

In another arrangement, the storage module may comprise a carousel structure for releasably securing a plurality of two-wheeled vehicles.

The carousel structure may comprise a base and a rotatable platform mounted on the base. The rotatable platform comprises a circular base portion and an upstanding portion on the radially inner side of the base portion. The upstanding portion is configured as a cylindrical wall portion.

The rotatable platform allows an operator sequentially install two-wheeled vehicles on the module from the one position. In this way, it is not necessary for the operator to have access all around the module; the operator simply stands in the one position and rotates the rotatable platform as necessary to bring it into appropriate position to receive each vehicle.

The rotatable platform is preferably so arranged that it can rotate under some resistance during movement of the vehicle. In this way, the weight of the rotatable platform is used to dissipate forces imposed on the stowed vehicles during acceleration and braking of the vehicle to an acceptable level.

According to a second aspect of the invention there is provided a method of storing items comprising utilisation of the remote storage system according to the first aspect of the invention.

According to a third aspect of the invention there is provided a method of storing items comprising: establishing a plurality of contact areas in different locations for a discrete time period dependent upon the movements of a transportation vehicle that circulates between contact points, a staging area and a storage area; receiving items for storage from the contact area in the transportation vehicle; transporting the accumulated items together in the transportation vehicle to the staging area; receiving a plurality of said units at the staging area; and transporting said units in bulk from the staging area to the storage area.

Preferably, the method further comprises subsequently returning said units in bulk from the staging area to the storage area.

Preferably, the method further comprises returning items accumulated together as a unit to the plurality of contact areas to be available for collection.

Preferably, the method further comprises loading items received at the plurality of contact areas onto a storage module for transportation as said unit to the staging area.

Preferably, the items remain on the storage module during transportation between the plurality of contact, staging and storage areas.

Preferably, the items remain on the storage module during storage at the storage area, awaiting return to the staging area and thereafter to the plurality of contact areas.

The method may further comprise establishing one or more further contact areas, wherein the staging area may receive items from a plurality of contact areas.

Additionally, the method may further comprise establishing one or more routes each containing a number of the plurality of contact areas, whereby a contact area vehicle is allocated a respective route and deploys at each contact area found within the route.

Typically, the contact area vehicle would travel around the route until a certain period of time elapses or the storage capacity is exceeded.

According to a fourth aspect of the invention there is provided a transportable storage module for the transportation and storage of a wheeled vehicle, the storage module comprising a base portion and an upstanding portion, the base portion being adapted to receive and support a first wheel of the vehicle and the upstanding portion being adapted to receive and support a second wheel of the vehicle.

Preferably, the first wheel comprises a rear wheel of a two-wheeled vehicle and the second wheel comprises the front wheel of the vehicle.

Preferably, the upstanding portion comprises a wall upstanding from the base portion.

Preferably, the wall is disposed between two opposed sides of the base portion, whereby the module can accommodate vehicles on opposed sides of the wall. Typically, the wall is located centrally between the two opposed sides of the base portion.

Preferably, the base portion comprises first engaging means for receiving and releasably retaining the first wheel.

Preferably, the first engaging means is configured as a channel adapted to receive and frictionally retain the first wheel.

Preferably, the channel is configured to accommodate a range of first wheels of various sizes or shape.

Preferably, the first engaging means is adapted to permit some limited sideways rocking movement of the first wheel while being in a retained condition within the first engaging means.

Preferably, the upstanding portion comprises second engaging means for receiving and releasably retaining the second wheel.

Preferably, the second engaging means is configured as a clip adapted to receive and securely retain the first wheel.

Preferably, the storage module is provided with a plurality of corresponding first and second engaging means, whereby the module can accommodate a plurality of vehicles at any one time.

Preferably, there are a plurality of corresponding first and second engaging means on opposed sides of the upstanding portion, whereby the module can accommodate a plurality of vehicles at any one time on each side of the upstanding portion.

Preferably, the first and second engaging means are so positioned relative to each other that the second wheel is supported in an elevated condition above the base portion.

More particularly, it is preferable that the vehicle be so supported that the majority if not substantially all of the weight of the vehicle is supported onto base portion thorough the first wheel. In this way, the vehicle is suspended in a somewhat upright condition with the second wheel uppermost and the first wheel lowermost.

Such an arrangement is particularly advantageous in circumstances where the second wheel comprises a steerable front wheel supported in a steering fork assembly which is pivotally connected to the main frame of the a two-wheeled vehicle, and where the first engaging means is adapted to permit some limited sideways rocking movement of the first wheel while being in a retained condition. This is because the main part of the bicycle frame can swing about the steering axis during transportation, thereby dissipating some of the forces exerted on the constrained two-wheeled vehicle during transportation; for example, the arrangement facilitates dissipation of forces induced when the module on which the two-wheeled vehicle is constrained is moved and forces induced when the vehicle carrying the module undergoes a cornering manoeuvre. In other words, torsional forces are dispersed at the steering mechanism of the two-wheeled vehicle instead of through the frame of the two wheeled vehicle. The dissipation of such forces reduces the likelihood of the two-wheeled vehicle sustaining damage during transportation.

Preferably, the module is configured to facilitate transportation.

In this regard, the module may be configured to facilitate manoeuvring and lifting by a lifting apparatus such as a known fork lift or a pallet lifter.

The module may also incorporate means such as wheels or rollers to facilitate movement over a surface such as the ground, the floor of a storage venue or the load carrying platform within a transport vehicle.

According to a fifth aspect of the invention, there is provided a system for user control of the remote storage system comprising:
an instructing module or means operable to generate instructions, the instructions relating to the transport of an item, the secure storage of an item and the location of the transport means;
a processing module or means operable to process the instructions and action the instructions via the control of a transport module and a storage module;
a transport module or means operable to transport an item, including means to determine the immediate location of the transport module, and to broadcast the location for tracking purposes; and a secure storage module or means operable to securely store an item.

Preferably, the instructions are generated via a software application operable on a mobile communication device. In a preferred form, the software application comprises a mobile application that may be downloaded to a storage means of the mobile communications device.

Preferably, the instructions are processed and actioned via software scripts operable on a server. In a preferred form, the software scripts comprise a server application that may be downloaded to a storage means of the server.

Preferably, the transportation of an item comprises a contact area for collection of the items with the transportation module. In a preferred form, the contact area comprises a mobile venue incorporating a means for determining its immediate location and a communication means to relay its location to the server.

Preferably, the means to securely store an item comprises a storage area. In a preferred form, the storage area comprises a building for storage of items incorporating means for servicing or maintenance of stored items.

Preferably, the server has a continual communication link to the contact area and the storage area. In a preferred form, the continual communication link allows the server to send instructions to the contact area and the storage and receive information or data from the contact area and the storage area.

According to a sixth aspect of the invention, there is provided a method for user control of the remote storage system comprising:
storing electronic program instructions for generating instructions;
sending the instructions to a server, such that the server will process and action the instructions; and
receiving a response providing information and data regarding the actioning of the instructions.

According to a seventh aspect of the invention, there is provided a computer-readable storage medium on which is stored instructions that, when executed by a computing means, causes the computing means to perform the method according to the sixth aspect of the invention as hereinbefore described.

According to an eighth aspect of the invention, there is provided a computing means programmed to carry out the method according to the sixth aspect of the invention as hereinbefore described.

According to a ninth aspect of the invention, there is provided a data signal including at least one instruction being capable of being receive and interpreted by a computing system, wherein the instruction implements the method according to the sixth aspect of the invention as hereinbefore described.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic view of a first embodiment of the remote storage system according to the invention;

FIG. 2 is a schematic perspective view of a contact area forming part of the remote storage system of FIG. 1;

FIG. 3 is a schematic perspective view of a storage module employed in the remote storage system, the storage module being depicted with bicycles stowed thereon;

FIG. 4 is a schematic side view of the storage module, the storage module being depicted without bicycles stowed thereon;

FIG. 5 is a schematic fragmentary perspective view of the storage module, illustrating in particular rear wheels of several bicycles secured in position on the storage module;

FIG. 6 is a schematic fragmentary perspective view of the storage module, illustrating in particular the front wheels of several bicycles secured in position on the storage module;

FIG. 7 is a perspective view of a channel forming part of the storage module, the channel being configured to accommodate a rear wheel of a bicycle to secure the bicycle in position on the storage module;

FIG. 8 is a front view of the channel;

FIG. 9 is a perspective view showing greater detail of the arrangement to secure a front wheel of a bicycle in position on the storage module;

FIG. 10 is a schematic plan view of a vehicle carrying two storage modules;

FIG. 11 is a schematic side view of the two storage modules in the arrangement shown in FIG. 10;

FIG. 11 is a plan view of two of the storage modules shown in FIG. 10 engaged in a vehicle storage zone;

FIG. 12 is a schematic plan view of the loaded forward module shown in FIG. 11;

FIG. 13 is a schematic side view of the loaded forward module shown in FIG. 11;

FIG. 14 is a schematic end view of a variant to the channel in which it is recessed into the base portion on which it is mounted;

FIG. 15 is a schematic plan view of a vehicle carrying two storage modules in a second embodiment of the remote storage system according to the invention;

FIG. 16 is a side view of a storage module used in the second embodiment of the remote storage system;

FIG. 17 is a is a schematic plan view of the two storage modules in position on a load-carrying platform of the vehicle shown in FIG. 15;

FIG. 18 is a is a schematic side view of the two storage modules in position on the load-carrying platform of the vehicle;

FIG. 19 is a system diagram of a communication system forming part of, or for use in conjunction with, the remote storage system according to the invention, the communication system comprising a mobile communication device, a server, a contact area and a storage area;

FIG. 20 is a flow chart depicting flow of user interactions incorporating the process of the communication system; and

FIGS. 21 and 24 are screen shots depicting a number of user interactive functions provide by the communication system.

In the drawings like structures are referred to by like numerals throughout the several views. The drawings shown are not necessarily to scale, with emphasis instead generally being placed upon illustrating the principles of the present invention.

### DESCRIPTION OF EMBODIMENTS

The various embodiments of the remote storage system according to the invention are each directed to the storage of bicycles. In this regard, the remote storage system is particularly suitable for inner city environments and other locations at which there are destinations to which users wish to travel by bicycle but at which there are no readily available facilities for convenient storage of the bicycles. It should, however, be understood that the remote storage system is not limited to storage of bicycles and may find application in relation to other good and equipment, including for example other two-wheeled vehicles, and water sports equipment such as surfboards and paddleboards.

Broadly, each embodiment provides a storage system comprising a first location to which users (cyclists) ride their bicycles and leave the bicycles for storage. The bicycles are collected at the first location and transported to a second location to be held on a temporary basis until transportation to a third location at which the bicycles are held for a designated time until being returned to the first location or another location later for collection by the users. In this way, the remote storage system provides a facility which allows users to ride their bicycles to a selected site (represented by the first location), leave the bicycles in safe store, and later collect the bicycles for their return journey. Each bicycle may be collected from the same site at which it was left or from some other designated site. The storage period is typically the working day; however, the storage period can vary, depending upon the service offered and requirements of users.

As will be explained later, there may be support facilities at the first location. The support facilities may include ablution and changing facilities, as well as facilities for purchase of refreshments and light meals, and bicycle repair. Such facilities may be provided on a temporary basis each day, or the first location may be selected to be at a site where such facilities are already in existence.

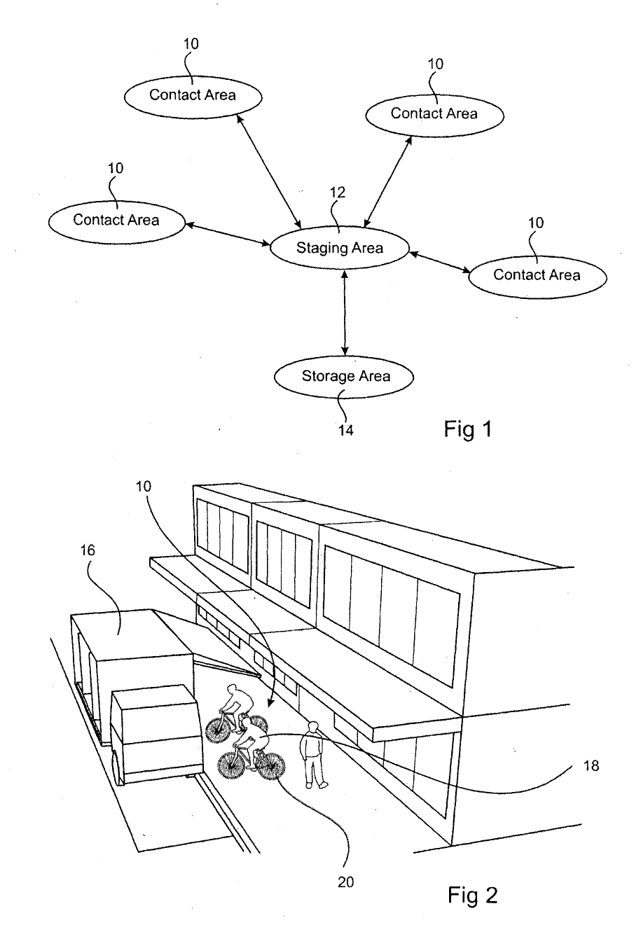

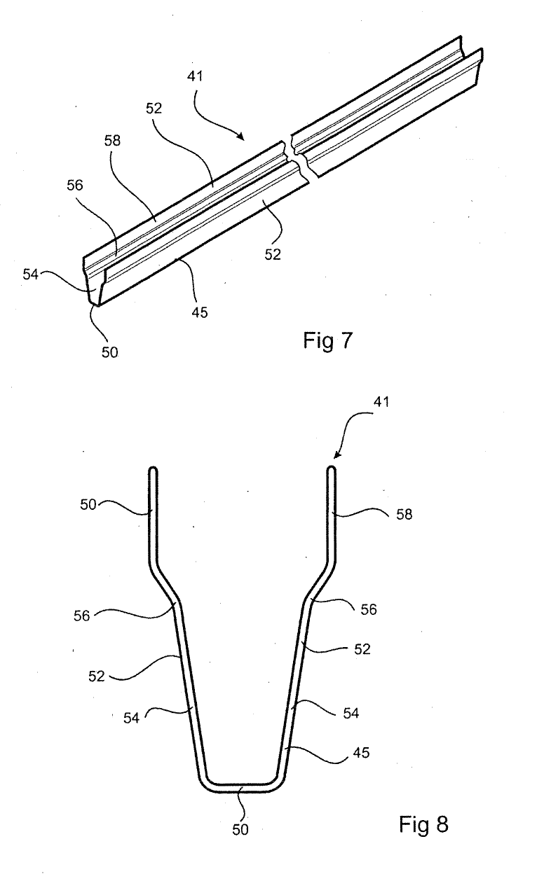

Referring now to FIGS. 1 to 13, the first embodiment of the remote storage system according to the invention comprises a contact area 10 which constitutes the first location, a staging area 12 which constitutes the second location, and a storage area 14 which constitutes the third location.

Typically, the remote storage system comprises a plurality of contact areas 10, although there may be instances in which there is need only for one contact area.

Where there are pluralities of contact areas 10, users would have a choice as to which particular contact area to use.

FIG. 1 depicts an arrangement in which there are several contact areas 10 for the collection and delivery of a number of bicycles, staging area 12 for the bulk collection of the bicycles, and storage area 14 for the secure storage of the bicycles.

Each of the contact areas 10 is configured for reception of bicycles 20 from users 18 during a certain time frame, such as the early morning. The bicycles 18 are ultimately transported to the storage area 14 which provides a secure area for storage for a certain duration of time, such as the main hours of the working day, and subsequently returned to the users at a later time, such as the late afternoon. In being transported from the contact area 10 to the storage area 14, the bicycles pass via the staging area 12 at which they are held temporarily, awaiting transportation in bulk to the storage area 14. The employment of the intervening staging area 12 allows vehicles which are used to collect bicycles from the contact areas 10 to move at relatively frequent intervals between the contact areas and the staging area in times of high user demand (such as at peak period in the mornings when cyclists are arriving at the contact areas to drop off their bicycles). Once demand has diminished, bicycles can be transported from staging area 12 to the storage area 14.

The contact areas 10 may take various forms, as will be explained later. Typically, a contact area vehicle 16, such as a small truck or a trailer towed by another vehicle, would be deployed at the contact area 10. In a preferred arrangement, the contact area vehicle 16 may be configured specifically for this purpose. Once the contact area vehicle 16 is deployed, users 18 would proceed to register their details with attending staff members and pass their bicycle 20 to the attending staff members for storage on storage modules 22, as will be described in more detail later. The use of storage modules 22 is advantageous as it allows for the rapid transport of a plurality of bicycles 20 on the storage modules without the need for handling the bicycles 20 individually. The contact area vehicle 16 would remain at the contact area 10 until a certain period of time has expired, such as for example two hours, or alternatively until the storage capacity of the contact area vehicle has been exceeded, in which case another contact area vehicle would be dispatched to the contact area 10 to relieve the current fully-loaded contact area vehicle. Once the period of time has expired or if the contact vehicle is at full capacity, bicycles aboard the contact area vehicle 16 would be transported to the staging area 12.

As mentioned above, the contact areas 10 may take various forms, including permanent locations and also transitory locations.

One form of contact area 10 may comprise a designated venue, such as area outside an office building, a large area of available land such as a car park, or a location nearby a mountain bike trail. Such designated venues represent permanent locations at which contact area 10 are established.

Another form of contact area 10 may comprise a location which is temporarily available for use. Such a location may provide an area at which a contact area vehicle 16 can park on a temporary basis but nevertheless for sufficient time to allow for collection of bicycles over a limited duration. Such a location represents a transitory location at which a contact area 10 is established by virtue of the presence of contact area vehicle 16 at that location. An example of such a location might be a zone on a road system designated for short-term use by vehicles. In Australia, zones designated for short term use by vehicles include so-called loading zones which are areas set aside for short-term use by certain vehicles when loading and unloading goods in the course of business and at which extended parking is not permitted. Typically, there are a number of loading zones dispersed within an inner city business district or commercial area.

In this scenario, the contact area vehicle 16 would be authorised to use loading zones on a short-term basis, and the driver of the contact vehicle would choose an available loading zone at which to park and establish a temporary contact area 10.

The selected loadings zones are likely to vary from day to day, subject to availability, but nevertheless would typically be in the same general vicinity and conveniently accessible to users. Preferably, there would be an associated identification system by which users could conveniently identify locations at which temporary contact areas 10 have been established. Further, it is possible that the particular loading zone selected to establish a temporary contact area 10 for the collection of bicycles may not necessarily be available later for the subsequent return of bicycles from storage to the respective users. Nevertheless, another loading zone would typically be available in the same general vicinity to establish a temporary contact area 10 for the return of bicycles.

A support vehicle (not shown) may be utilised to provide additional storage volume or additional facilities, such as a shower facilities, change room facilities, food preparation facilities and bicycle repair facilities.

Where there are a plurality of contact areas 10, as depicted in the arrangement shown schematically in FIG. 1, a route may be established between the various contact areas 10, or at least between a selected group of them, and one or more contact vehicles 16 may be designated to service that route. Typically, each contact area vehicle 16 would deploy at each contact area 10 along the route for a fixed amount of time before advancing to, and deploying at, the next contact area 10. Additionally, the route may be a looped route around which the contact area vehicle 16 would continually travel, visiting each contact area 10 in turn. Typically, the contact area vehicle 16 would travel continually around the route until a certain period of time has elapsed or the storage capacity was exceeded.

The staging area 12 is a designated venue, such as a large parking lot or a park, for the bulk collection of the loaded storage modules 22 from the contact area vehicles 16. The contact area vehicles 16 will travel to the staging area 12 and transfer the loaded storage modules 22 containing the bicycles 18 to a point of collection. The point of collection is typically a staging area vehicle (not shown), such as a large truck, for deployment at the staging area 12. Once the staging area vehicle is deployed, the contact area vehicles 16 would proceed to transfer their loaded storage modules containing the bicycles to the staging area vehicle. The staging area vehicle would typically remain at the staging area 12 until a certain period of time has expired, such as three hours, or until storage capacity has been exceeded whereupon another staging area vehicle would typically be dispatched to the staging area 12 to relieve the current fully-loaded staging area vehicle. Thereafter, the loaded storage modules 22 at the point of collection at the staging area 12 would be transported to the storage area 14.

The staging area 12 may be a designated venue at which a large land area is available for deployment. In this situation, there may be more than one a point of collection at the staging area 12; for example, more than one staging area vehicle may be utilised, thereby providing additional storage capacity.

Furthermore, there may be a requirement for more than one staging area 12, with each contact area vehicle 16 travelling to a designated staging area 12.

The storage area 14 is typically a static storage venue, comprising a large storage area, such as a warehouse, for the secure storage of the loaded storage modules 22 containing the bicycles. The staging area vehicle would transport the loaded storage modules 22 to the storage area 14 and proceed to transfer the loaded storage modules to the large storage area. The storage modules 22 would remain at the storage area 14 until a period of time has expired, such as six hours. Once the period of time has expired, the storage area 14 would consolidate the loaded storage modules 22 and transfer them to the staging area vehicles. The above mentioned method is then reversed for the purposes of delivering the bicycles to the original users.

Additionally, the storage area 14 is also configured to allow for the storage of the staging area vehicle, the contact area vehicles and the storage modules when they are not in use.

Furthermore, there may be a requirement for more than one storage area 14.

Each contact area vehicle 16 typically comprises a small truck which is readily manoeuvrable about roads on which it is required to travel between contact areas 10, as well as between contact areas 10 and staging area 12. In the arrangement shown, the contact area vehicle 16 comprises a driver's cab 17 and a load-carrying platform 19 behind the cab for carrying the storage modules 22. The load-carrying platform 19 is accessible for load and unloading of the storage modules from each side 19a and the rear 19b.

The storage modules 22 on which the bicycles are loaded for transportation and storage may be of any appropriate form.

It is advantageous that the storage modules 22 be configured as pallets on which bicycles can be accommodated and which are configured to be lifted and transported using a forklift or a pallet trolley. This arrangement is advantageous as it allows for the rapid transport of a plurality of bicycles 20 without the need for handling the bicycles individually. Further, if, for example, a contact area vehicle 16 should encounter mechanical difficulty, another contact area vehicle can be readily deployed to take over the role of the malfunctioning contact area vehicle. In such circumstances, the loaded storage modules 22 can be transferred from the malfunctioning contact area vehicle to the replacement contact area vehicle without handling the bicycles 20 stowed on the storage modules.

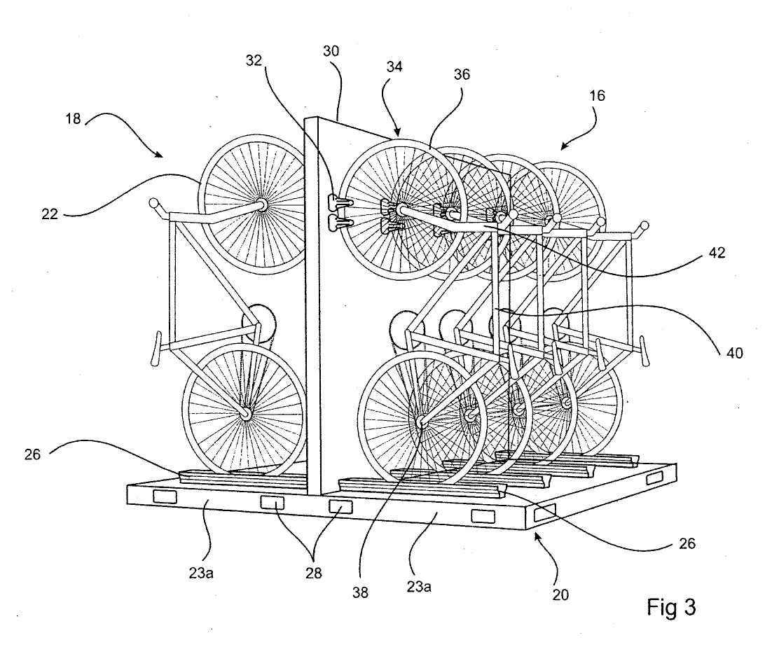

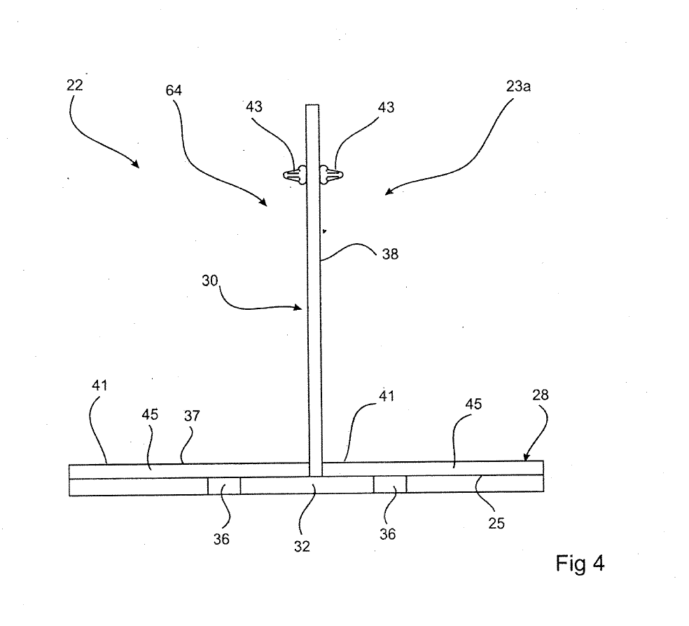

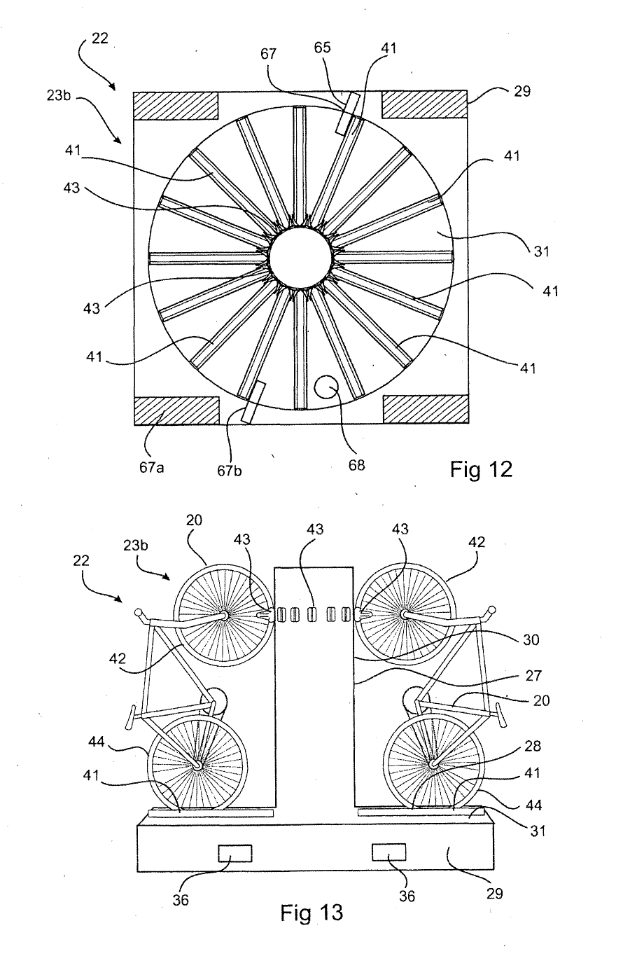

In this embodiment, there are two configurations of storage modules 22, one configuration being identified by reference numeral 23a and the other by reference numeral 23b. Storage module 23a is best seen in FIGS. 3 and 4, and storage module 23b is best seen in FIGS. 12 and 13. Each configuration 23a, 23b has provision for receiving and releasably securing a plurality of bicycles 20, as will be explained in detail later.

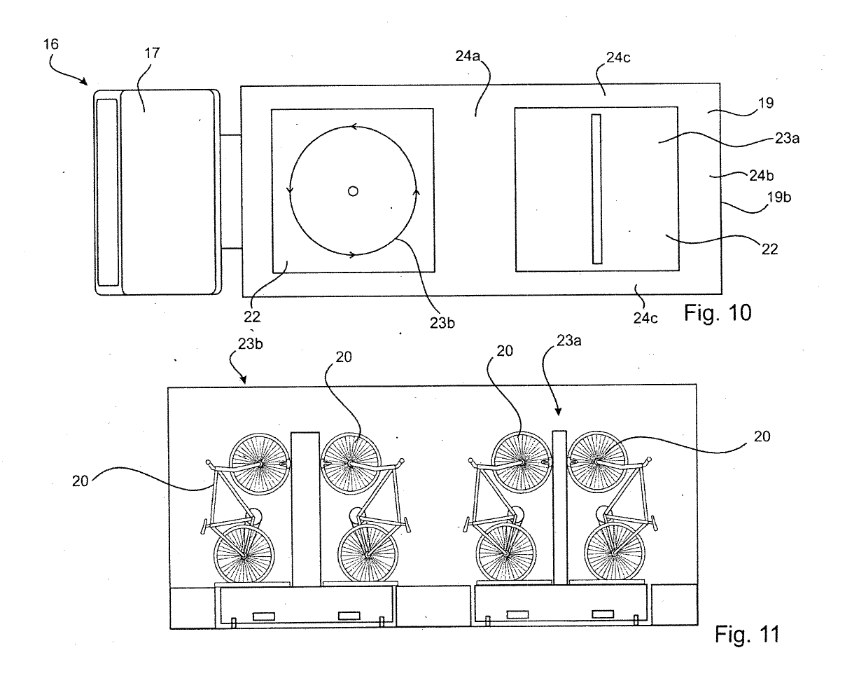

The storage modules 22 are used in both configurations in this embodiment. The storage module 23a is located on the rearward section of the load-carrying platform 19 adjacent the rear 19b, and the storage module 23b is located on the forward section of the load-carrying platform 19 adjacent the cab 17, as best seen in FIG. 10. The arrangement is to facilitate access to the modules 22 by an operator (who typically would also be the vehicle driver) for installation of bicycles on the modules at the contact area 10, as will be explained on more detail later. The storage modules 23a, 23b are arranged in position on the load-carrying platform 19 such that there is an access area 24a between the two storage modules, an access area 24b between the rearward storage module 23a and the rear 19b of the platform, and preferably also access areas 24c on each side of the rearward storage module 23a.

The storage module 23a comprises a body 25 having a base portion 28 and an upstanding portion 30, as best seen in FIGS. 3 and 4.

The base portion 28 comprises a base 32 incorporating a pair of openings 36 for the engagement of lifting elements such as lifting prongs of a forklift or pallet trolley. The base 32 presents an upper surface 37.

The upstanding portion 30 comprises an upstanding wall 38 at a central position on the base portion 28.

The storage module 23a has provision for releasably securing a plurality of bicycles on the body 25. In this embodiment, this is accomplished by releasably retaining the wheels of each bicycle 20 on the body 25. Other securing arrangements are, of course possible.

In the arrangement illustrated, the base portion 28 comprises a first engaging means 41 for receiving and releasably retaining one wheel 44 of each bicycle. With this arrangement, the wheel 44 represents the rear wheel of the bicycle 20.

The wall portion 30 comprises second engaging means 43 for receiving and releasably retaining the retaining the other wheel 42 of each bicycle. With this arrangement, the wheel 42 represents front wheel of the bicycle 20.

The first and second engaging means 41, 43 are so positioned relative to each other that the front wheel 42 is supported in an elevated condition above the base portion 26. More particularly, the bicycle 20 is so supported that the majority, if not substantially all, of its weight is supported onto base portion 26 through the rear wheel 44. In this way, the bicycle is suspended in a somewhat upright condition with the front wheel uppermost and the rear wheel lowermost, as best seen in FIG. 3.

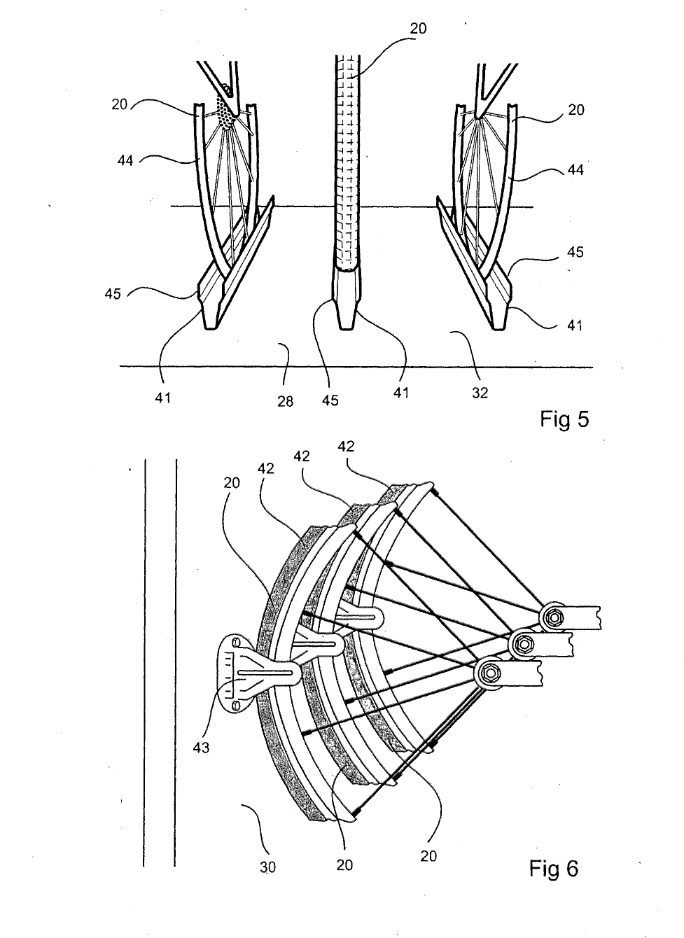

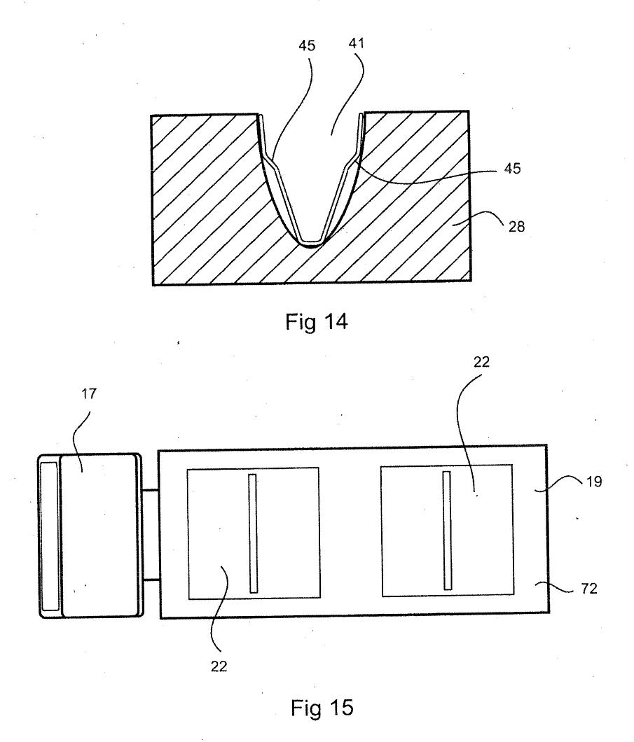

In the arrangement shown, the first engaging means 41 is configured as a channel 45 mounted on the base portion 28. The channel 45 may be mounted on the upper surface 37 of the base portion 28, as shown in FIG. 5, or it may be accommodated within the confines of the base portion 28 so as to not extend upwardly beyond the upper surface, as shown in the variant depicted in FIG. 14. The latter arrangement is advantageous in that the channel 45 does not provide an impediment extending upwardly above the upper surface 37 of the base 32.

The bicycle 20 is secured to the storage module 23a by securing a front wheel 42 to the upstanding portion 30 via the second engaging means 43, and placement of a rear wheel 44 in the channel 45. This arrangement orientates the bicycle 20 in a vertical position, with the front wheel 42 being secured to the standing wall portion 30 and immobilised to inhibit any movement of the front wheel 42 in any direction. The bicycle 20 then hangs down from the front wheel 42, allowing for the rear wheel 44 to be engaged in the channel 45. The rear wheel 44 is snugly engaged by the channel 45 and abutted against the standing wall portion 30. This position allows for the bicycle 20 to be secured in the pallet 26, where external forces of reasonable magnitude would not cause the rear wheel 44 to slip within the channel 45. The vertical position of the bicycle 20 inhibits torsion forces to impart stress and strain upon the bicycle frame 46, instead the torsion forces are directed to the bicycle steerer pole 48 which is designed to manage torsion forces when a user is steering the bicycle 20.

In this embodiment, the modules 23a are positioned so that the standing wall portions 30 are transverse to the fore and aft axis (i.e. direction of travel) of the vehicle. The transverse orientation of the standing wall portion 30 can serve to resist forces imposed upon the bicycles 20 during acceleration and braking of the vehicle. With this arrangement, the vertical position of the bicycle 20 in conjunction with the securement to the upstanding portion 30 allows the upstanding portion to resist forward and backward forces during acceleration and braking of the vehicle. Additionally, the level of gas in the front wheel 42 produces a cushioning effect, assisting in the absorption and dissipation of incurred forces during the acceleration and braking of the vehicle.

The channel 45 is configured as a tapered channel comprising of a flat base 50, and a pair of walls 52, as best seen in FIG. 8. The walls 52 defines a plurality of sections adapted to accommodate various sizes of wheels. In the arrangement shown there are three sections, being a lower section 54, a middle section 56 and an upper section 58. The lower section 54 comprises outwardly tapered walls of a small angle. The middle section 56 comprises outwardly tapered walls of a larger angle. The upper section 58 comprises straight walls perpendicular to the base 50. With this arrangement, the channel 45 can accommodate the rear wheel 44 of various sizes and various levels of gas inflation. This can be seen in FIG. 5 in which three rear wheels 44 of different sizes are shown accommodated in the respective channels 45. The configuration of the channel 45 facilitates frictional engagement of the rear wheel 44 in the channel, inhibiting slippage of the rear wheel 44 during transport of the storage module. Additionally, a securing means (not shown), such as a stopper, can be located in the channel 45 to arrest movement of the rear wheel 44 and thereby prevent it from disengaging from the channel 45.

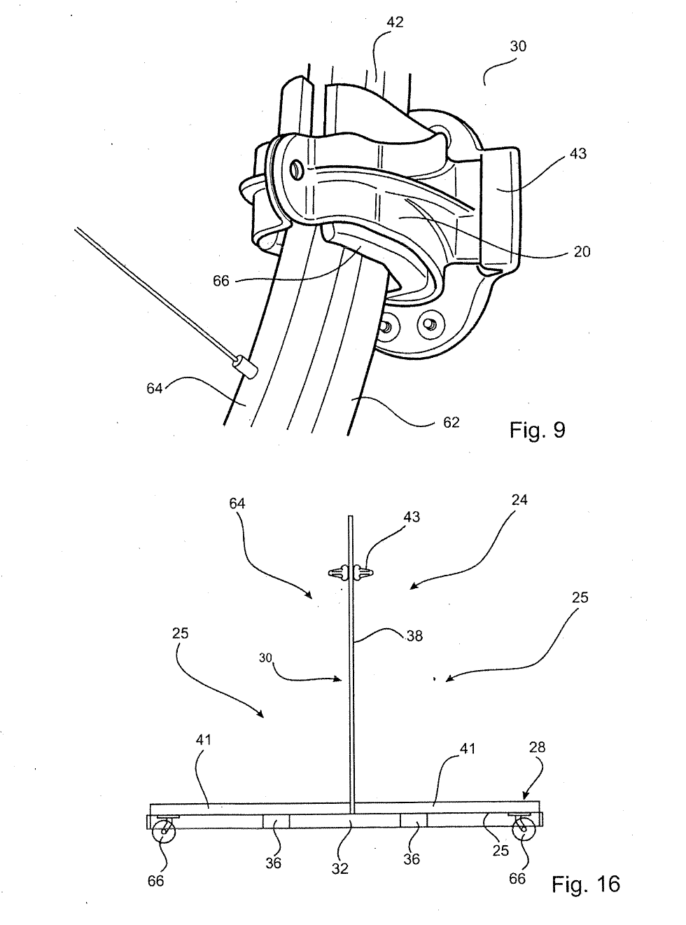

The second engaging means 43 for securing and immobilising the front wheel 42 against the upstanding portion 30 is best seen in FIGS. 6 and 9. The second engaging means 43 comprises a vice-grip 60, which is adapted to grip around a front wheel tyre 62 and a front wheel rim 64, securing and immobilising the front wheel 42 against any movement. Additionally, the vice-grip may accommodate padding 66 within the grip portion to ensure that smaller front wheels of a narrower size can be secured by the vice-grip 60.

The storage module 23a defines two storage zones 25 on opposed sides of the upstanding portion 30, with each storage zone being adapted to receive a plurality of bicycles 20. Accordingly, each storage zone 25 incorporates a plurality of counterpart channels 44 and vice-grips 60. This arrangement is advantageous as stowed bicycles 20 in the two storages zones will experience different forces during acceleration and braking of the vehicle. In particular, stowed bicycles 20 in one zone would experience a “pull” force and stowed bicycles 20 on the other storage zone would experience a “push” force during acceleration and braking. This ensures that different forces will act upon the steerer pole 48 of each bicycle 20, so repeated wear will not incur.

The storage module 23b is also configured as a pallet on which bicycles can be accommodated and which are configured to be lifted and transported using a forklift or a pallet trolley.

Broadly, the storage module 23b differs from storage module 23a in that it incorporates a carousel structure 27 for releasably securing a plurality of bicycles.

The storage module 23b has a number of features in common with the strobe module 23a and so like reference numerals are used to denote like parts.

The carousel structure 27 comprises a base 29 and a rotatable platform 31 mounted on the base 29. The base 29 incorporates a pair of openings 36 for the engagement of lifting elements such as lifting prongs of a forklift or pallet trolley.

The rotatable platform 31 comprises a circular base portion 28 and an upstanding portion 30 on the radially inner side of the base portion. The upstanding portion 30 is configured as a cylindrical wall portion.

The rotatable platform 31 is supported on the base 29 through a bearing arrangement which typically comprises a ball-bearing structure. The region of the base 29 surrounding the circular base portion 28 is preferably built-up to the level of the base portion 29, thereby effecting a relatively even transition between the two adjacent surfaces. This is considered advantageous form the perspective of safety for the operator as it avoids the presence of a stepped edge which could be hazardous.

The storage module 23b has provision for releasably securing a plurality of bicycles 20 on the rotatable platform 31. In this embodiment, this is accomplished by releasably retaining the wheels of each bicycle 20 on the rotatable platform 31 in a manner similar to storage module 23a. Other securing arrangements are, of course possible.

In the arrangement illustrated, the base portion 28 comprises a first engaging means 41 for receiving and releasably retaining one wheel 44 of each bicycle. With this arrangement, the wheel 44 represents the rear wheel of the bicycle 20.

The upstanding portion 30 comprises second engaging means 43 for receiving and releasably retaining the retaining the other wheel 42 of each bicycle. With this arrangement, the wheel 42 represents front wheel of the bicycle 20.

The first and second engaging means 41, 43 are so positioned relative to each other that the front wheel 42 is supported in an elevated condition above the base portion 28. More particularly, the bicycle 20 is so supported that the majority of its weight is supported onto base portion 28 through the rear wheel 44. In this way, the bicycle is suspended in a somewhat upright condition, with the front wheel uppermost and resting against the upstanding portion 30 and the rear wheel lowermost, as best seen in FIGS. 11 and 13.

In the arrangement shown, the first engaging means 41 is configured as a channel 45 mounted on the base portion 28.

The bicycle 20 is secured to the rotatable platform 31 by securing a front wheel 42 to the upstanding portion 30 via the second engaging means 43, and placement of a rear wheel 44 in the channel 45. This arrangement orientates the bicycle 20 in a generally vertical position, with the front wheel 42 being secured to the inclined upstanding portion 30 and immobilised to inhibit any movement of the front wheel 42 in any direction. The bicycle 20 then hangs down from the front wheel 42, allowing for the rear wheel 44 to be engaged in the channel 45. The rear wheel 44 is snugly engaged by the channel 45 and abutted against the standing wall portion 30. This position allows for the bicycle 20 to be secured in the storage module 23b in a manner in which external forces of reasonable magnitude would not cause the rear wheel 44 to slip within the channel 45.

The rotatable platform 31 allows an operator to sequentially install bicycles on the forward module 23b from the one position, typically while standing at the access area 24a between the two storage modules 23a, 23b. In other words, it is not necessary for the operator to have access all around the forward storage module 23a; the operator simply needs to stand in the one position and rotate the rotatable platform 31 as necessary to bring it into appropriate position to receive each bicycle. Such an arrangement is advantageous as it facilitates effect use of space on the load-carting platform 19, as the presence of the cab 17 can be an impediment to access.

As discussed previously, the rearward modules 23a are positioned so that the upstanding wall portion 30 is transverse to the fore-and-aft axis (i.e. direction of travel) of the vehicle to facilitate resistance to forces imposed upon the bicycles 20 during acceleration and braking of the vehicle. This arrangement is not available with the forward storage module 23b because bicycles are spaced at intervals around the rotatable platform 31. As a consequence, while some resistance would likely be afforded by the upstanding portion 30 to bicycles disposed at leading and trailing segments of the rotatable platform 31, there would be little, if any, resistance to bicycles disposed at the side segments of the rotatable platform 31.

With a view to addressing this issue, the rotatable platform 31 is so arranged that it can rotate under some resistance during movement of the vehicle 16. In this way, the weight of the rotatable platform 31 can be used to dissipate the forces to an acceptable level with which the tyre channels 45 can cope. When there is a sudden acceleration or braking effect, the increased weight on the rear wheel 44 of the bicycle 20 which is laterally outermost on the relevant side of the rotatable platform 31 will cause it to spin. The rotational movement, together with the retarding effect to the rotation provided by the resistance, serves to dampen forces imposed on the bicycles through forward and backward forces arising during acceleration and braking of the vehicle, as well as sideways forces arising during cornering of the vehicle.

The resistance to rotation can be effected in any appropriate way. In this embodiment, there is a retarding mechanism 65 associated with the rotatable platform 31. In this embodiment, the retarding mechanism 65 comprises a plurality of resistance brakes 67 such as dampers operable between the base 29 and the rotatable platform 31. In the arrangement shown, the resistance brakes 67 comprise chocks 67a mounted on the base 29 and in frictional sliding engagement with the rotatable platform 31. Further, the resistance brakes 67 comprise damper strips 67b mounted on the base 29 and in frictional sliding engagement with the rotatable platform 31.

The rotatable platform 31 is eccentrically balanced so as to assist in inducing rotation during vehicle movement. In the arrangement illustrated, the eccentric balancing is provided by a weight 68 provided on the rotatable platform 31 at a location offset from the axis of rotation of the platform.

A release mechanism (not shown) is also provided for selectively removing at least part of the retarding force imposed by the retarding mechanism 65 so that the rotatable platform 31 can more freely rotate This is for the purpose of allowing the operator to manually move the platform 31 more freely when loading bicycles onto, and removing bicycles from, rotatable platform 31 In the arrangement illustrated, the release mechanism (not shown) is operable to move the chocks 67a out of frictional sliding engagement with the rotatable platform 31.

The channels 45 used in the forward module 23b are similar to the channels used in the rearward module 23a and so will not be described further. The channels 45 may be mounted on the upper surface of the circular base portion 28 or may be accommodated within the confines of the circular base portion 28 so as to not extend upwardly beyond the upper surface thereof. The latter arrangement is advantageous in that the channels 45 do not provide impediment extending upwardly above the upper surface of the circular base portion 28.

Similarly, the second engaging means 43 for securing and immobilising the front wheel 42 of each bicycle against the upstanding portion 30 are similar to the arrangements used in the rearward module 23a and so will not be described further

In the arrangement shown, the carousel structure 27 is sized and configured to accommodate 14 bicycles at nominal angular spacings of 25.7 degrees. However, the carousel structure 27 can, of course, be sized and configured to accommodate any other suitable number of bicycles.

Because of its construction, the storage module 23b is likely to be suitable for relatively small bicycles only; for example, bicycles with a seat height of less than about one metre. Because of this, the rearward storage module 23a would likely be allocated to larger bicycles.

A bicycle lift system (not shown) may be provided for lifting bicycles onto the load-carrying platform 19 of the contact area vehicle 16 from ground level after delivery of the bicycles to the contact area 10. The bicycle lift system may also be used to lower the bicycles from the load-carrying platform 19 to ground level at the contact area 10 to return the bicycles to their owners and thereby complete the storage process. The use of the bicycle lift system is advantageous as it reduces strain likely to be imposed on the operator in handling the bicycles as they are raised onto, and lowered from, the load-carrying platform. The bicycle lift system may comprise a rack or other support onto which a bicycle is loaded, and a lift mechanism for raising and lowering the rack. The lift mechanism may be manually operable or may configured as a power lift mechanism. The power lift mechanism may be electrically operated using a battery power supply.

In the embodiment described above, the contact area vehicle employed two storage modules 22, being rearward storage module 23a and forward storage module 23b. Other arrangements are, of course possible. In some cases there may be only one module, and in other cases there may be more than two modules. It is considered that two modules is likely to be a convenient number to provide a system which is sufficiently agile to manoeuvre along inner city and suburban roads while having sufficient capacity to provide an efficient and cost-effective arrangement.

Further, in some arrangements, the modules may be each of the same type; for example, in one arrangement the modules may each be in the form of modules 23a and in another arrangement the modules may each be in the form of modules 23b. Still further, the modules may be of some other configuration which nevertheless still allows for the rapid transport of a plurality of bicycles 20 without the need for handling the bicycles 20 individually.

The storage modules 22 can also be configured as a number of additional arrangements utilised for transportation and storage, such as a trolley or a stackable cage.

Referring now to FIGS. 15 to 18, there is shown features of a second embodiment of a storage system according to the invention. In this embodiment, the, the storage modules 22 are each configured as a wheeled pallet 68. The wheeled pallet 68 is similar to the rearward storage module 24a employed with the first embodiment except for the incorporation of castor wheels 70. Preferably, the castor wheels 70 are swivel castor wheels to allow for the omni-directional wheeling of the wheeled pallet 68. This arrangement is advantageous as it allows for the ease of movement of the wheeled pallet 68 when fully occupied by stowed bicycles 20.

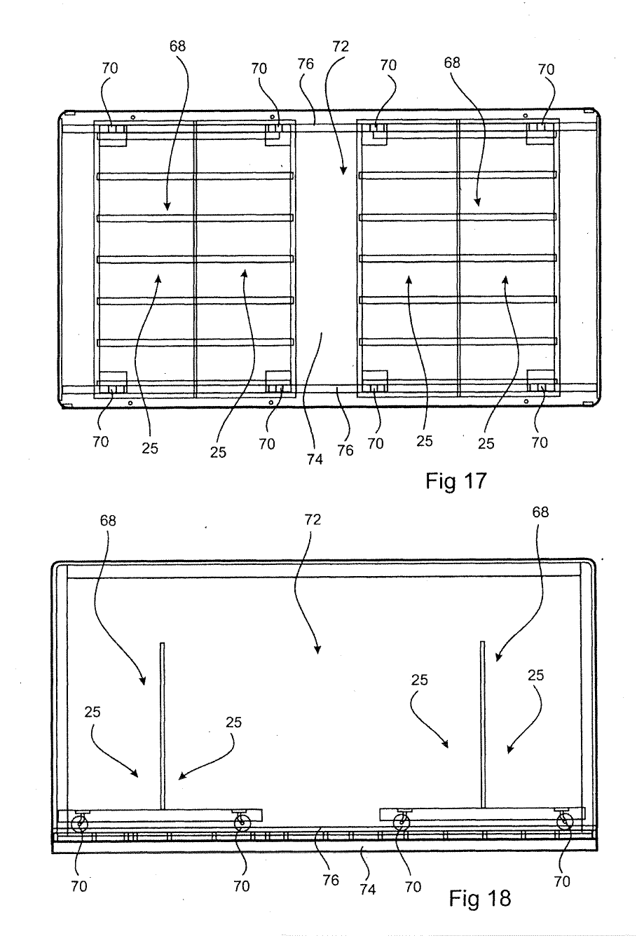

FIGS. 17 and 18 depicts an arrangement for mounting the wheeled pallet 68 in a vehicle storage zone 72 defined by the load-carrying platform 19 of the contact area vehicle 16. The vehicle storage zone 72 comprises a base portion 74 and a pair of guide rails 76. The distance between the pair of guide rails 76 is the same distance between the castor wheels 70 to allow for the wheeled pallet 68 to be slotted onto the base portion 74. To stop the wheeled pallet 68 from sliding along the pair of guide rails 76, a securing means, such as a pin, is provided to block the path of the castor wheels 70. This arrangement is advantageous as it prevents the collision of the wheeled pallet 68 with another wheeled pallet 68 or the walls of the vehicle storage zone 72 during loading, unloading and transit of the wheeled pallet 68, thereby reducing the probability that the stowed bicycles 20 incurring damage.

The wheeled configuration of the pallets 68 allows the pallets to be moved relative to each other on the load-carrying platform 19 into close proximity for compact storage and to be moved apart to provide access for loading and unloading of bicycles.

As mentioned above, the remote storage system according to the invention may include provision for user control, whereby users (cyclists) can identify locations at which contact areas 10 have been established. Further, the provision for user control system allows a user to locate the closest contact area 10 and determine whether the contact area 10 has available space to accommodate the user's bicycle 20. The user can then book an available storage space at the contact area 10 and have the contact area 10 collect the bicycle 20 for storage at the storage area 14. This process is reversed for the delivery of the bicycle 20 to the user from the storage area 14. Further, there may be provision for the user to arrange for the storage of the bicycle 20 at the storage area 14 for an extended period of time. Additionally, there may be provision for the user to arrange for the maintenance or servicing of the bicycle 20 while stored at the storage area 14. Still further, there may be provision for the user to interact with other users through social media. This allows for the sharing of knowledge, establishment of reputations for brands and additional revenue generation via advertisements.

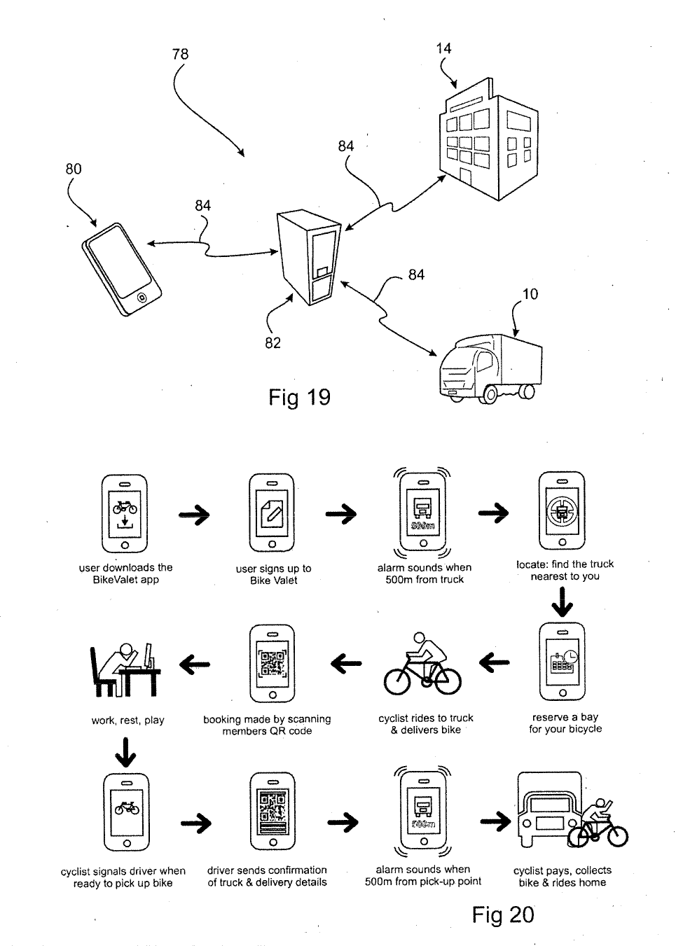

FIG. 19 depicts an example of a system 78 for user control of the remote storage system according to the invention. The system 78 comprises a mobile communication device 80, a server 82, as well as the contact area 10 and the storage area 14.

The device 80 and the server 82 both comprise a plurality of components, subsystems or modules operably coupled via appropriate circuitry and connections to enable the device 80 and the server 82 to perform the functions and operations herein described. The device 80 and the server 82 comprise suitable components necessary to receive, store and execute appropriate computer instructions such as a method for generating instructions, sending instructions and receiving information or data.

The server 82 is adapted to utilise scripts to automatically process instructions received from the device 80, action the instructions and provide a response or report to the device 80. The scripts allow for the automatic generation of instructions to the contact area 10 and the storage area 14, and the retrieval of information or data from the contact area 10 and the storage area 14.

The contact area 10 and the storage area 14 incorporate means for receiving instructions from the server and sending information or data to the server. The means may incorporate mobile computing devices such as a digital assistant, a mobile data terminal, a portable data terminal, a smart phone, a tablet computer, ultra-mobile personal computer or a wearable computer.

Furthermore, the contact area 10 incorporates means for determining the location of the contact area 10. Typically, such means incorporates a navigation system utilising a satellite navigation receiver to provide a location state in Cartesian coordinates. Typically, the navigation system is in communication with the mobile data terminal to allow for the sending of the real time location of the contact area 10 to the server for monitoring purposes.

Communication between all constituents is accomplished via one or more communications links 84. At least one of a plurality of communications links 84 may be connected to an external computing network through a telecommunications network.

The user control of the remote storage system is initiated by the execution of computer instructions on the device 80 to generate and send an instruction to a server 82 via a communications link 84. The server 82 receives the generated instruction and processes the instructions. The instructions comprising a request of services, such as for example, booking for the retrieval or delivery of a bicycle 20, booking for the storage of the bicycle 20, booking for the maintenance or servicing of the bicycle 20 in storage, location state of the contact area 10, and generation of a unique user identification profile. The server 82, after initiating the processing of the instruction, sends instructions to the contact area 10 or the storage area 14. The contact area 10 or the storage area 14 will provide a response to the instructions from the server 82 acknowledging receipt of the instructions and a further response determining whether the instruction can be actioned. Upon receiving the response from the contact area 10 or the storage area 14, the server 82 will send a response to the device 80 providing a report of the status of the request.

Instructions to the contact area 10 may comprise of a request to reserve a storage space for the retrieval of the user's bicycle 20, the delivery of the user's bicycle 20 or the broadcast of the current location state of the contact area 10.

Instructions to the storage area 14 may comprise of a request to reserve a storage space for the storage of the bicycle 20, and the maintenance or servicing of the bicycle 20 while in storage.

Additionally, the server 82 may be adapted to process generated instructions from the device 80 requesting weather status and updates regarding the user's bicycle 20, and facilitate user payments for use of the remote storage system.

The device 80 typically comprises a processor, a storage medium for storing electronic program instructions for execution by the processor, information or data, a display for displaying a user interface and a user input means. The components of the device 10 are typically housed within a container or housing.

The device 80 is operable by the processor performing actions under control of the electronic program instructions, such as dispatching instructions and managing the flow of data and information through the device 80.

The electronic program instructions are provided via a single software application which may hereinafter be referred to as a valet app. Using the single application, a user can manage the remote storage system and access information pertaining to the remote storage system, the user's bicycle 20 and social media applications relating to the remote storage system.

In preferred embodiments of the invention, the device 80 comprises a smart phone such as that marketed under the trade mark IPHONE® by Apple Inc. or by other providers such as Sony Corporation or Samsung Group, having Android, WEBOS, Windows, iOS or other mobile operating systems. Alternatively, the device 80 may comprise other computing means such as a personal, notebook or tablet computer such as that marketed under the trade mark IPAD® by Apple Inc., or by any other provider such as Fujitsu Limited or ASUSTeK Computer Inc. for example.

The valet app for the computing components of the device 80 can be written in any suitable programming language, as are known to persons skilled in the art, such as for example, JavaScript and C++.

The device 80 also includes an operating system which is capable of issuing commands and is arranged to interact with the valet app to cause the device 80 to carry out the respective steps, functions and/or procedures in accordance with the embodiment of the invention described herein.

Once the valet app is installed on the device 80, the processor is operable, under control of the valet app, to present, via the display, a sequence of electronic pages, screens and forms to a user allowing for the inputting or capture of instructions or commands pertinent to the generation of instructions.

FIG. 20 demonstrates the use of the system 78 by a user according to a first embodiment.

Initially the user downloads the valet app to the device 80, such as for example an IPHONE®. The user initialises the valet app establishing a communication link 84 between the user device 80 and the server 82. The valet app then requests the input of user information in order to either register the user to allow operation of the system 78 or establish that the user is an existing operator of the system 78. After the valet app has established the user as an operator of the system 78, a unique Quick Response code is generated and associated with the user.

The valet app is configured to alert the user via a physical, aural or visual alarm whenever the user is within a predetermined distance from a contact area 10. The user is then able to locate the nearest contact area 10 via the valet app.

The user is able to request the collection of a bicycle 20 by the contact area 10 via the valet app and receive confirmation whether the nearest contact area 10 has available storage space. If the nearest contact area 10 has available storage space, the user will then deliver the bicycle 20 to the contact area 10, at which the user will verify their status as an operator of the system 78 via the scanning of the unique Quick Response code.

When the user requires the bicycle 20, the user is able to request the delivery of the bicycle 21 by the contact area 10 via the valet app. The valet app will then provide delivery details. Additionally, the valet app will alert the user via the physical, aural or visual alarm when the contact area 10 is within a predetermined distance. Finally, the user will collect the bicycle 20 from the contact area 10.

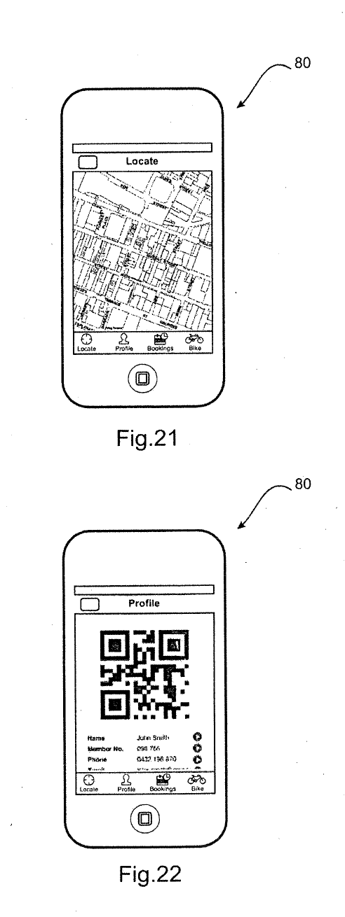

FIG. 21 demonstrates an example of what may be referred to as a “Locate” screen displayed via the display upon execution of the valet app. It is to be appreciated that this, and the other screens illustrated in the figures of the specification, are examples of screen shots of the embodiment. In other embodiments of the invention, these may be altered to suit user demand, feedback or to improve functionality. As such, other screens may have differing visual appearances.

Interface elements in the form of interactive buttons are provided on all screens of the valet application allowing the user to access the “Locate” screen, the “Profile” screen, the “Bookings” screen or the “Bike” screen.

Execution of the “Locate” button leads to the “Locate” screen, an electronic road atlas, an example of which is depicted in FIG. 21 being automatically displayed on the display of the device 80. In this embodiment, the centre of the road atlas is the current location state of the user, while the icons are indicative of the location state of a number of contact areas 10. The road atlas is updated on a periodic basis to maintain the user's current location state as well as to update the location state of the contact areas 10.

Execution of the “Profile” button leads to a “Profile” screen, a list of the user's information, an example of which is depicted in FIG. 22, being automatically displayed on the display of the device 80. The “Profile” screen displays a unique Quick Response Code, name, membership number and contact details. Prior to the display of the list of the user's information, it will be necessary to complete a registration form in order to generate the user's unique Quick Response Code and membership number. In this embodiment, the Quick Response Code is used to register the user's bicycle at a contact area 10 for delivery to or retrieval from a storage area 14.

Execution of the “Bookings” button leads to a “Bookings” screen, an example of which is depicted in FIG. 23, being automatically displayed on the display of the device 80. In this embodiment, the “Bookings” screen displays a number of interactive elements which allow for the retrieval or delivery of a user's bicycle at a specified time, date and contact area.

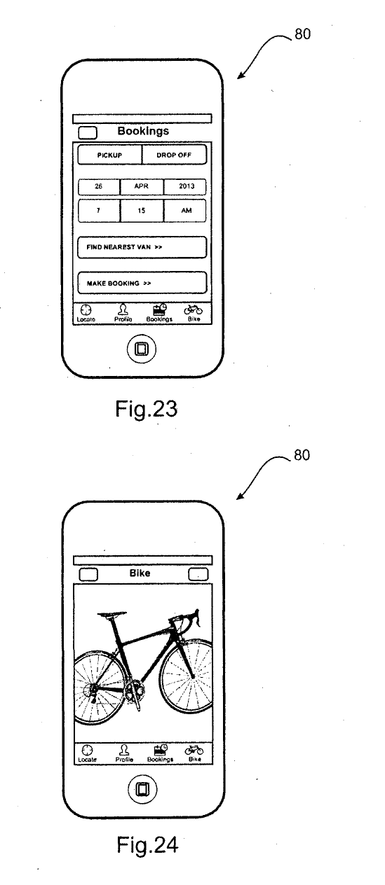

Execution of the “Bike” button leads to a “Bike” screen, an example of which is depicted in FIG. 24, being automatically displayed on the display of the device 80. In this embodiment, the “Bike” screen displays a picture of the user's bicycle. A number of interactive elements allow for the use of a camera integrated within the device 80 for uploading pictures of the user's bicycle for storage, and displaying details of the user's bicycle, such as for example, custom modifications to the bicycle and the make of the bicycle. Furthermore, the details and pictures of the user's bicycle can be shared with other users of the remote storage system via social media such as an online forum or Facebook® by Facebook Inc.

This embodiment of the invention provides several advantages.

Firstly, it allows a user to locate the closest contact area 10 and determine whether the contact area 10 has available space for the retrieval of the user's bicycle 20. The user can then book an available storage space on the contact area 10 and have the contact area 10 collect the bicycle 20 for storage at the storage area 14. This process is reversed for the delivery of the bicycle 20 to the user from the storage area 14.

Secondly, it allows the user to arrange for the storage of the bicycle 20 at the storage area 14 for an extended period of time. Additionally, the user can arrange for the maintenance or servicing of the bicycle 20 while stored at the storage area 14.

Thirdly, it allows the user to interact with other users through social media. This allows for the sharing of knowledge, establishment of reputations for brands and additional revenue generation via advertisements.

It should be appreciated that the scope of the invention is not limited to the scope of the embodiments described.

While an aspect of the invention has been referred to as a remote storage system, it may also be considered to be a remote storage facility, a remote storage assembly or a remote storage arrangement operating over the three locations described (being the contact, staging and storage areas), together with the associated infrastructure (including in particular the storage modules) to facilitate movement of items between those three locations.

It should also be appreciate that the storage modules according to the invention need not necessarily be limited to use in conjunction with the remote storage system according to the invention. The storage modules according to the invention may find application in the transportation and/or storage, of two-wheeled vehicles, including in particular bicycles.

Modifications and variations such as would be apparent to the skilled addressee are considered to fall within the scope of the present invention.

Reference to positional descriptions, such as upper and lower, are to be taken in context of the embodiments depicted in the figures, and are not to be taken as limiting the invention to the literal interpretation of the term but rather as would be understood by the skilled addressee.

Throughout this specification, unless the context requires otherwise, the word “comprise” or variations such as “comprises” or “comprising”, will be understood to imply the inclusion of a stated integer or group of integers but not the exclusion of any other integer or group of integers.

Additionally, where the terms “system”, “device”, and “machine are used in the context of the invention, they are to be understood as including reference to any group of functionally related or interacting, interrelated, interdependent or associated components or elements that may be located in proximity to, separate from, integrated with, or discrete from, each other.

1. A remote storage system for items, comprising of a plurality of contact areas at different locations for the collection of the items individually, a storage area for secure storage of the items received from the plurality of contact areas, and one or more transportation vehicles for receiving and offloading the items at the plurality of contact areas and one or more conveying vehicles for transporting the items to and from the storage area, wherein the one or more transportation vehicles circulate between the plurality of contact areas so that each of the plurality of contact areas exists for a discrete time period dependent on the arrival of a transportation vehicle.

2. The remote storage system as claimed in claim 1, wherein the one or more conveying vehicles are the one or more transportation vehicles.

3. The remote storage system according to claim 1, further comprising a staging area for the collection of items in larger quantities than from the plurality of contact areas.

4. The remote storage system according to claim 1, wherein the plurality of contact areas comprise a transitory location.

5. The remote storage system according to claim 1, wherein the plurality of contact areas comprise a designated venue.

6. The remote storage system according to claim 3, wherein the staging area comprises a designated area for the collection of items in larger quantities from the plurality of contact areas and holding the collection of items on a temporary basis prior to dispatch in bulk quantities to the storage area.

7. The remote storage system as claimed in claim 6, wherein the one or more transportation vehicles moves items between the plurality of contact areas and the staging area.

8. The remote storage system as claimed in claim 6, wherein the one or more conveying vehicles moves items between the staging area and the storage area.

9. A remote storage system for items, comprising of a temporary contact area for the collection of the items individually, a storage area for secure storage of the items received from the contact area and one or more transportation vehicles for receiving and offloading the items at the temporary contact area and transporting them to and from the storage area, wherein the temporary nature of the contact area is defined by the movements of the transportation vehicles.

10. The remote storage system as claimed in claim 9, comprising a plurality of temporary contact areas for the collection of the items individually, a storage area for secure storage of the items received from the plurality of contact areas and one or more transportation vehicles for receiving and offloading the items at the plurality of temporary contact areas and transporting them to and from the storage area, wherein the temporary nature of the plurality of contact areas is defined by the movements of the transportation vehicles.

11. The remote storage system as claimed in claim 10 further comprising apparatus to receive the items for transportation and storage.

12. The remote storage system according to claim 11, wherein the apparatus comprises a storage module.

13. The remote storage system according to claim 12, wherein one or more storage modules are delivered to each of the plurality of contact areas and the items delivered to the plurality of contact areas for storage are loaded onto the one or more storage modules for transportation to the staging area and wherein the modules together with the items loaded thereon are retained temporarily at the staging area and thereafter transported to the storage area for storage.

14. The remote storage system according to claim 13, wherein each storage module comprising a base portion and an upstanding portion.

15. The remote storage system according to claim 1, wherein the items comprise two-wheeled vehicles.

16. The remote storage system according to claim 15, wherein the base portion is adapted to receive and support a first wheel of the vehicle and the upstanding portion being adapted to receive and support a second wheel of the vehicle.

17. The remote storage system according to any one of claims 12, wherein the storage module has provision for releasably securing a plurality of two-wheeled vehicles in position on the module.

18. The remote storage system according to claim 12, wherein the storage module comprises a carousel structures for releasably securing a plurality of two-wheeled vehicles.

19. A method of storing items comprising utilisation of the remote storage system according to claim 1.

20. A method of storing items comprising: establishing a plurality of contact areas in different locations for a discrete time period dependent upon the movements of a transportation vehicle that circulates between contact points, a staging area and a storage area; receiving items for storage from the contact areas in the transportation vehicle; transporting the accumulated items together in the transportation vehicle to the staging area; receiving a plurality of said items at the staging area; and transporting said items in bulk from the staging area to the storage area.

21. The method according to claim 20, further comprising subsequently returning said items in bulk from the staging area to the storage area.

22. The method according to claim 20, wherein the items remain on the storage module during transportation between the plurality of contact, staging and storage areas.

23. The method according to claim 20, wherein the items remain on the storage module during storage at the storage area, awaiting return to the staging area and thereafter to the plurality of contact areas.

24. The method according to claim 20, further comprising establishing one or more routes each containing a number of the plurality of contact areas, whereby a contact area vehicle is allocated a respective route and deploys at each contact area found within the route.
